(19) United States
(12) Patent Application Publication
(10) Pub. No.: US 2011/0220149 A1
(43) Pub. Date: Sep. 15, 2011

(54) SPRAY DEVICE FOR AN APPLIANCE AND METHOD OF OPERATION

(76) Inventor: RAMASAMY THIYAGARAJAN, Louisville, KY (US)

(21) Appl. No.: 13/116,446

(22) Filed: May 26, 2011

Related U.S. Application Data
(63) Continuation-in-part of application No. 11/475,672, filed on Jun. 27, 2006.

(51) Int. Cl. A47L 15/42; B05B 7/00

(52) U.S. Cl. 134/18; 239/61; 134/56 D

(57) ABSTRACT

A spray device and method for operating an appliance for washing objects, such as spray dishwashers, wherein the spray device rotates in two directions (e.g., clockwise and counterclockwise) to improve spray coverage of the objects.

### CROSS-REFERENCE TO RELATED APPLICATIONS

This application is a continuation-in-part of U.S. application Ser. No. 11/475,672 entitled SPRAY DEVICE FOR A DISHWASHER AND METHOD OF OPERATION, filed Jun. 27, 2006.

### BACKGROUND OF THE INVENTION

1. Field of the Invention

The subject matter disclosed herein relates generally to appliances, and more particularly, to appliances that contain a spray device for washing objects.

2. Description of Related Art

Various types of appliances for washing objects (e.g., dishwashers) are known and are in use. For example, a spray dishwasher used for domestic applications uses detergent dissolved in warm water that is sprayed to wash dishes stacked in racks. In particular, the spray dishwasher employs devices for spraying water such as a rotating spray arm that sprays water through multiple holes formed on the arm.

Typically, washability of the spray dishwasher is a function of parameters such as solvent (e.g., water) flow rate, solvent coverage, nozzle geometry, nozzle size, RPM of the spray arm, jet force, particle filtration, wash time, temperature of the solvent, detergent composition, chemical energy, etc. The wash cycle of the spray dishwasher requires sufficient solvent flow rate, solvent coverage, thermal energy, and chemical energy. Further, the rinse cycle of the spray dishwasher requires solvent flow rate and coverage that is sufficient for removing detergent and excess food particles from the dishes. Thus, the rinse cycle requires a relatively lower solvent flow rate as compared to the wash cycle for maintaining the same coverage.

The amount of solvent and other parameters required for effective washability is also determined by the particular solvent coverage and mechanical energy provided by the solvent when sprayed over the objects in that appliance. The more effective coverage and mechanical energy, the lower the amounts of the other parameters that are required to achieve the same or better wash performance. For example, if the entire portion of a dish (e.g., the inside of a glass) is sprayed with the solvent at a relatively high jet force, a lower temperature solvent with a less powerful detergent may be used to wash the dish in a shorter wash time than if the dish was not exposed to good coverage and mechanical energy, reducing the amount of water and energy needed.

In a conventional spray dishwasher, a single hydraulic system is employed for all modes of operation of the dishwasher cycle such as pre-wash, wash and rinse cycles. Further, the solvent flow rate is same for all these modes of operation. In addition, this single hydraulic system rotates the spray arms in a single direction (i.e., clockwise or counterclockwise), which typically will result in some portion of a dish that is not sprayed by the solvent, especially when a user does not load the dishes into the racks in the appliance following the recommended loading instructions for optimum performance. For example, the spray may only contact a dish on one side when the spray arms only rotate in a single direction. When there is lower solvent coverage, this requires greater solvent flow rates and wash times, higher solvent temperatures, and more powerful detergents to accomplish the required cleaning. As a result, such appliances utilize greater amounts of water and energy for washing the dishes.

Accordingly, a need exists for providing an appliance that utilizes substantially lower amounts of water and energy for washing objects. It would also be desirable to provide a spray device for the appliance that provides sufficient coverage for all modes of operation of the appliance while maintaining the low washing solvent usage.

### BRIEF DESCRIPTION OF THE INVENTION

The inventor has developed concepts that, when implemented in connection with appliances that contain a spray device for washing objects, such as spray dishwashers, rotate the spray device in two directions (e.g., clockwise and counterclockwise) to improve spray coverage of the objects. Further discussion of these concepts, briefly outlined above, is provide below in connection with one or more embodiments.

According to one embodiment, a spray device for an appliance for washing objects is provided. The spray device has a first spray arm having a first set of nozzles configured to introduce a solvent within the appliance in a manner that drives the first spray arm to rotate in a first direction, a second spray arm having a second set of nozzles configured to introduce the solvent within the appliance in a manner that drives the second spray arm to rotate in a second direction, wherein the second direction is opposite of the first direction, a pumping system coupled to the first spray arm and the second spray arm, and a control system configured to control a flow of the solvent from the pumping system to the first spray arm and to control a flow of solvent from the pumping system to the second spray arm.

In another embodiment, an appliance is provided. The appliance has a sump configured to store solvent for washing objects placed in the appliance, a spray device configured to spray the solvent from the sump over the objects, wherein the spray device comprises a first spray arm having a first set of nozzles configured to introduce the solvent within the appliance in a manner that drives the first spray arm to rotate in a first direction, a second spray arm having a second set of nozzles configured to introduce the solvent within the appliance in a manner that drives the second spray arm to rotate in a second direction, wherein the second direction is opposite of the first direction, a pumping system coupled to the sump and configured to pump solvent contained in the sump to the first spray arm and the second spray arm, and a control system configured to control a flow of the solvent from the pumping system to the first spray arm and to control a flow of solvent from the pumping system to the second spray arm.

In another embodiment, a method of operating a spray device of an appliance is provided. The method includes the steps of introducing a solvent within the appliance in a manner that drives the first spray arm to rotate in a first direction, introducing the solvent within the appliance in a manner that drives the second spray arm to rotate in a second direction, wherein the second direction is opposite of the first direction, controlling a flow of the solvent from a pumping system of the appliance to the first spray arm and controlling a flow of solvent from the pumping system to the second spray arm.

### BRIEF DESCRIPTION OF THE DRAWINGS

Reference is now made briefly to the accompanying drawings in which:

FIG. 1 is a side sectional view of an embodiment of an appliance for washing objects having a spray device;

FIG. 2 illustrates an exemplary configuration of the spray device employed in the appliance of FIG. 1;

FIG. 3 is a diagrammatical illustration of inlets for two spray arms of the spray device of FIG. 2;

FIG. 4 is a diagrammatical illustration of tubing for supplying water to the two spray arms of the spray device of FIG. 2;

FIG. 5 illustrates flow path of water within the first spray arm of the spray device of FIG. 2;

FIG. 6 illustrates flow path of water within the second spray arm of the spray device of FIG. 2; and

FIG. 7 illustrates an exemplary operational cycle for the appliance of FIG. 1.

Where noted, like reference characters designate identical or corresponding components and units throughout several views, which are not to scale unless otherwise noted.

### DETAILED DESCRIPTION OF THE INVENTION

The embodiments of the appliance described in detail below function to provide an appliance for washing objects (e.g., a dishwasher) that utilizes substantially lower amounts of water and energy for washing the objects. In particular, the spray device for the appliance provides sufficient coverage for all modes of operation while maintaining low washing solvent usage. In one embodiment, the appliance contains a spray device that rotates in two directions (e.g., clockwise and counterclockwise) to improve spray coverage of the objects.

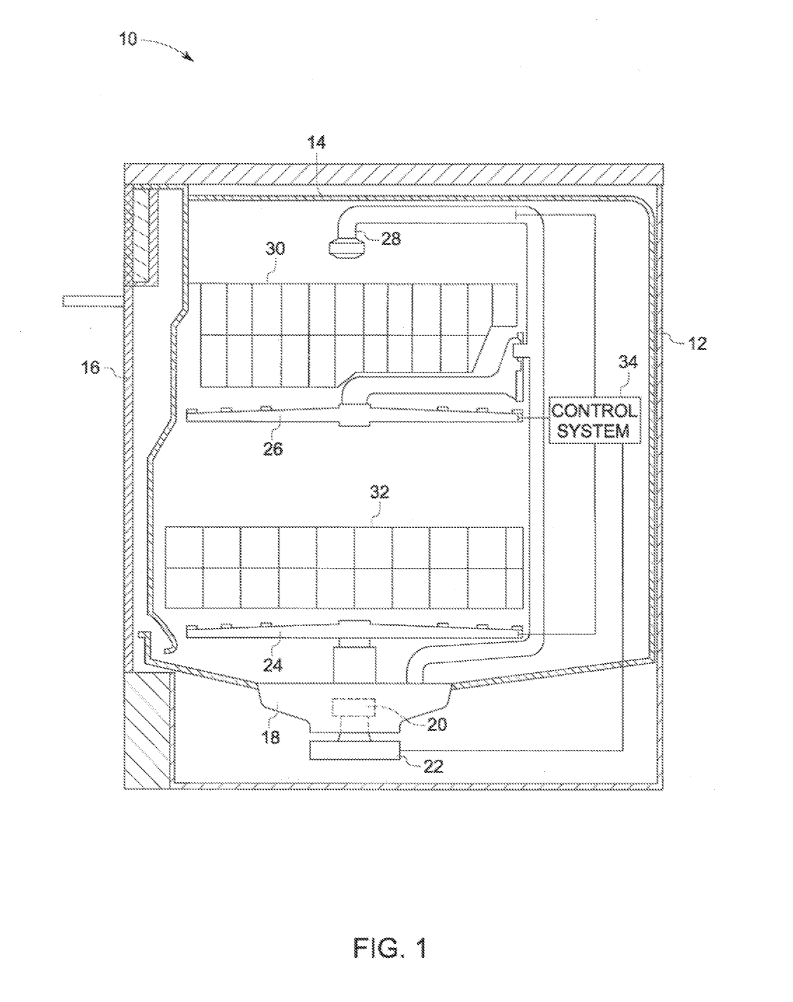

Referring now to the drawings, FIG. 1 is a side sectional view of an appliance 10 for washing objects, and more particularly a spray dishwasher that is configured to wash dishes with a solvent such as water sprayed through a spray device. The concepts are not intended to be limited to any particular type or configuration of the appliance 10, such as the configuration and features of a spray dishwasher. The appliance 10 has an enclosing cabinet 12 and a tub 14 installed in the cabinet 12 to define a dish washing chamber. Further, the appliance 10 has a door 16 installed in the front of the tub 14 to open or close the dish washing chamber and a sump 18 installed on the bottom center of the tub 14 to store washing water.

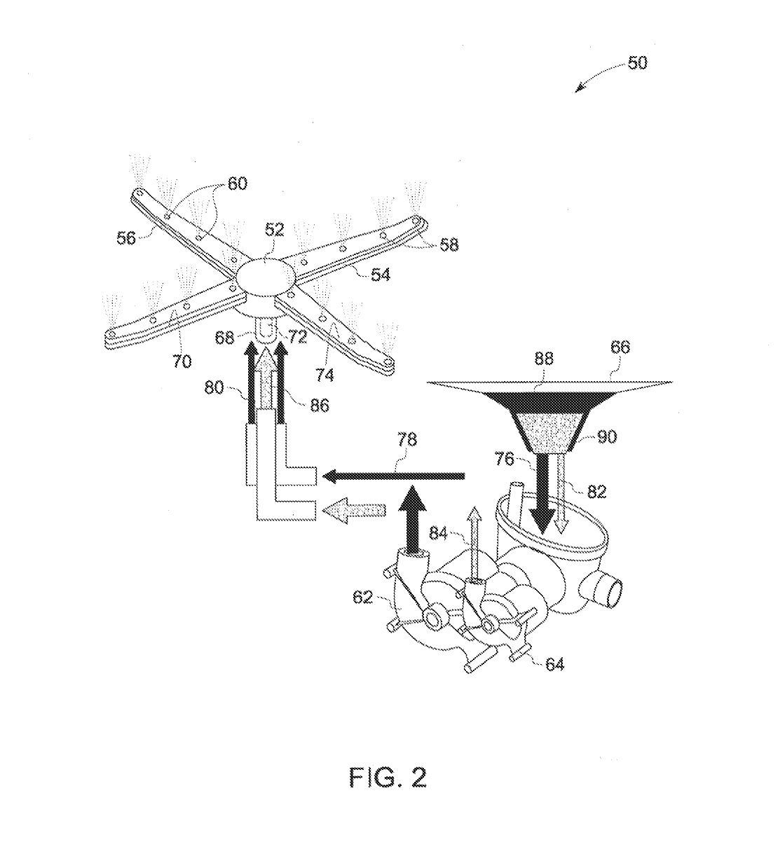

In addition, the appliance 10 has a pump 20 that is in fluid communication with the sump 18 to pump washing water stored in the sump 18. A motor 22 is drivingly coupled to the pump 20 for driving the pump 20. Further, the appliance 10 has spray devices such as represented by reference numerals 24, 26 and 28 for spraying the water received from the pump 20 over the dishes loaded in washing racks 30 and 32 within the tub 14. As illustrated, the spray devices 24, 26 and 28 may be located above or below the washing racks 30 and 32 depending upon a design of the appliance 10. In the illustrated embodiment, the spray devices 24 and 26 include a dual spray arm configuration to spray water on the dishes during different modes of operation of the appliance 10. Further, a control system 34 is coupled to the spray devices 24 and 26 for controlling the operation of the spray devices based upon a mode of operation of the appliance 10. The dual spray arm configuration of the spray devices 24 and 26 will be described in detail below with reference to FIGS. 2-6.

FIG. 2 illustrates an exemplary configuration of the spray device 50 employed at least for one of and preferably for both spray devices 24 and 26 in the appliance 10 of FIG. 1. The spray device 50 has a hub 52. A first spray arm 54 is mounted to the hub 52 and is configured to introduce a solvent such as water within the dish washing chamber (see FIG. 1) in a first mode of operation of the appliance 10. Further, the spray device 50 has a second spray arm 56 mounted to the hub 52 and configured to introduce water within the dish washing chamber in a second mode of operation of the appliance 10. In the illustrated embodiment, the second spray arm 56 is transverse to the first spray arm 54. The term “transverse” is used herein to refer arrangements wherein the long dimensions of the spray arms are not aligned, i.e. where the first spray arm and the second spray arm extend from the hub along different radial axes. In the illustrated embodiment, the arms are disposed perpendicularly to one another; however, other configurations having different orientation of the first and second spray arms 54 and 56 may be envisaged.

Further, the first spray arm 54 has a first set of nozzles 58 and the second spray arm 56 has a second set of nozzles 60 for spraying water over the dishes within the dish washing chamber during first and second modes of operation respectively. In one exemplary embodiment, the first mode of operation includes a wash cycle and the second mode of operation includes a rinse cycle or a pre-wash cycle.

The spray device 50 also has a first pump 62 coupled with the first spray arm 54 and a second pump 64 coupled to the second spray arm 56. In operation, the first and second pumps 62 and 64 are in fluid communication with a sump 66 and are configured to pump washing water contained in the sump 66 for washing or rinsing cycles. In the illustrated embodiment, a flow rate of the first pump 62 is different than a flow rate of the second pump 64, while in other embodiments the flow rate of the first pump 62 is the same as the flow rate of the second pump 64. In certain embodiments, the spray device 50 has a single pump and a valve system (not shown) employed for selectively directing water from the pump to the first and second spray arms 54 and 56.

In operation, based upon a mode of operation of the appliance 10, the flow of water to the first and second spray arms 54 and 56 is controlled via the control system 34 (see FIG. 1). For example, during a wash cycle of the appliance 10, the first pump 62 is operated to pump the water from the sump 66 to the first spray arm 54 through a first inlet 68. In this exemplary embodiment, the spray device 50 has a first channel 70 in fluid communication with the first inlet 68 and the first set of nozzles 58. Similarly, during a rinse cycle or a pre-wash cycle of the appliance 10, the second pump 64 is operated to pump the water from the sump 66 to the second spray arm 56 through a second inlet 72. Again, the spray device has a second channel 74 in fluid communication with the second inlet 72 and the second set of nozzles 60. The flow path of water for the wash cycle is indicated by reference numerals 76, 78 and 80 and the flow path of water for the pre-wash or a rinse cycle is indicated by reference numerals 82, 84 and 86. It should be noted that the rinse cycle or the pre-wash cycle requires a relatively lower water flow rate as compared to the wash cycle. Therefore the water level in the sump 66 may be maintained at different levels such as represented by reference numerals 88 and 90 for the wash cycle and the pre-wash or rinse cycle respectively. Thus, the sump 66 may be designed based upon a desired flow rate and cavitation.

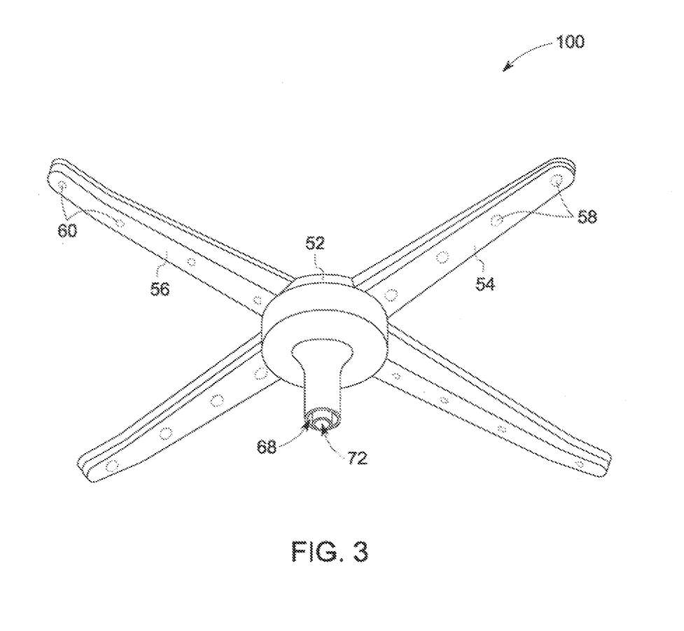

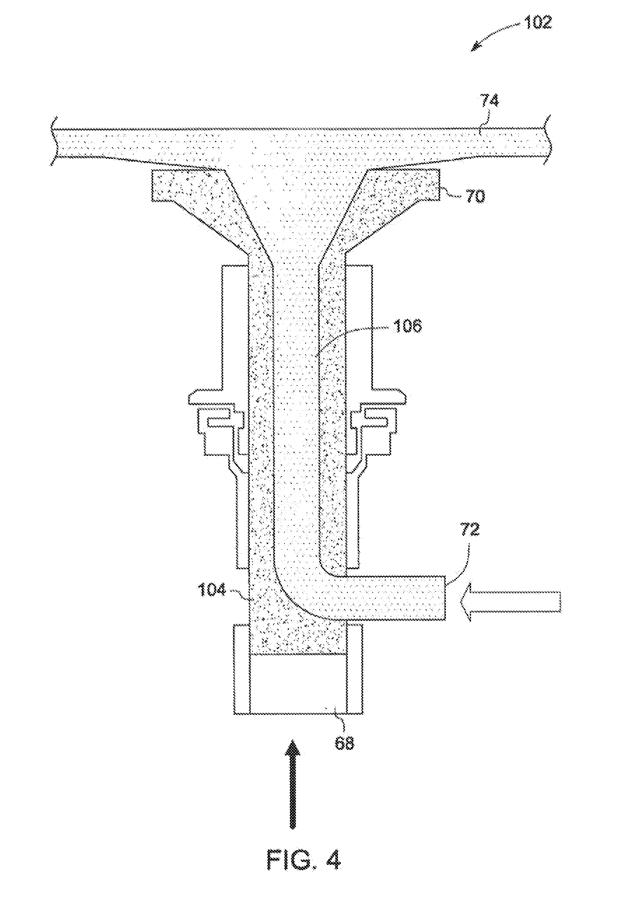

FIG. 3 is a diagrammatical illustration of an exemplary configuration of a spray device 100 with first and second inlets 68 and 72 for two spray arms 54 and 56 of the spray device 50 of FIG. 2. As illustrated, the first and second inlets 68 and 72 are disposed in a concentric configuration. Based upon a mode of operation of the appliance 10 (see FIG. 1) water may be pumped to the first or second inlets 68 and 72 for wash or pre-wash/rinse cycles. Further, the flow of water through the first and second inlets 68 and 72 is directed to the first and second set of nozzles 58 and 60 through the first and second channels 70 and 74 as illustrated in FIG. 4.

FIG. 4 is a diagrammatical illustration of tubing 102 for supplying water to the two spray arms 54 and 56 of the spray device 50 of FIG. 2. In the illustrated embodiment, during wash operation, the water from the first pump 62 (see FIG. 2) is provided to the spray device 50 via inlet 68 and through tubing 104. Similarly, during rinse or pre-wash operation, the water from the second pump 64 (see FIG. 2) is provided to the spray device 50 via inlet 72 and through tubing 106. The first and second pumps 62 and 64 may be selectively operated to provide the water through the tubing 104 and 106 based upon the mode of operation of the appliance 10. In certain embodiments, a valve system (not shown) may be employed to divert the water through the tubing 104 or 106. Further, the flow of water is directed to the first and second set of nozzles 58 and 60 though first and second channels 70 and 74 respectively. In the illustrated embodiment, the first and second channels 70 and 74 include concentric tubes within the spray device 50 and the corresponding mating component such as a hub line filter (not shown).

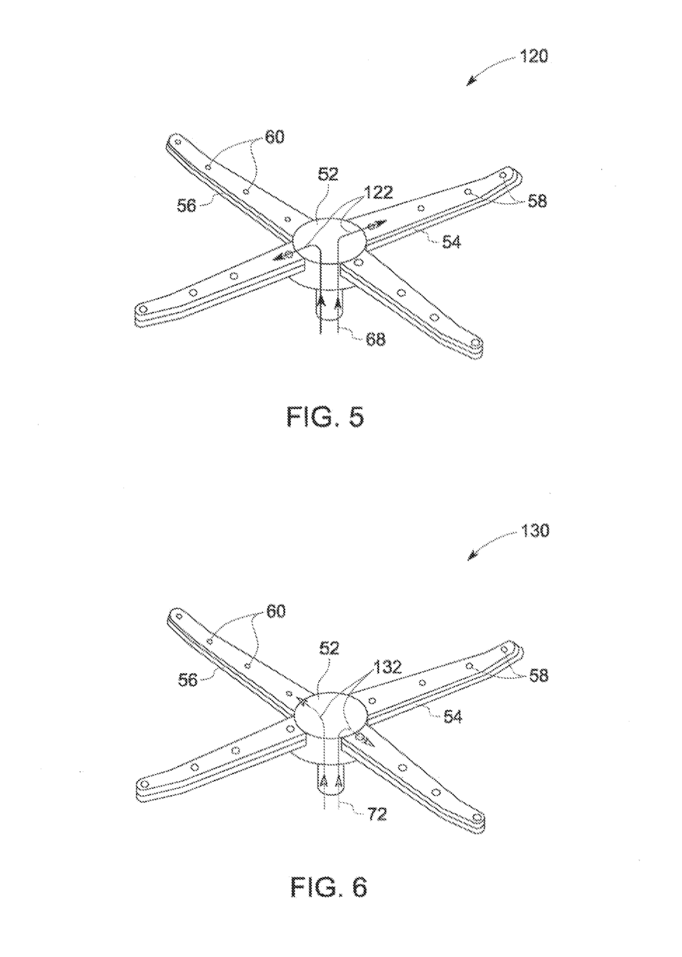

FIG. 5 illustrates flow path 120 of water within the first spray arm 54 of the spray device 50 of FIG. 2. As illustrated, during the wash cycle, water enters the first inlet 68 and is directed to the first set of nozzles 58 of the first spray arm 54 as represented by reference numeral 122. This flow of water 122 is then sprayed on the dishes for a pre-determined period of time of the wash cycle. It should be noted that the direction of the water jet controls the direction of rotation of spray arm 54 along with its rotations per minute (RPM). In certain embodiments, a spherical nozzle design is employed for providing flexibility for changing the angle of the water jets. FIG. 6 illustrates flow path 130 of water within the second spray arm 56 of the spray device 50 of FIG. 2. In this exemplary embodiment, during the pre-wash cycle or the rinse cycle, water enters the second inlet 72 and is directed to the second set of nozzles 60 of the second spray arm 56 as represented by reference numeral 132. Again, this flow of water 132 is sprayed on the dishes for a pre-determined period of time of the pre-wash or rinse cycle. In this exemplary embodiment, the first and second inlets 68 and 72 and the first and second set of nozzles 58 and 60 may be designed based upon a desired wash performance.

Comparative testing of the performance of a dishwasher of the type illustrated in FIG. 1, embodying the spray arm arrangement herein described for spray arms 24 and 26, with representative dishwashers currently commercially available has shown that for comparable cycle times and water temperatures, comparable or better wash performance can be achieved with lower water consumption and energy consumption.

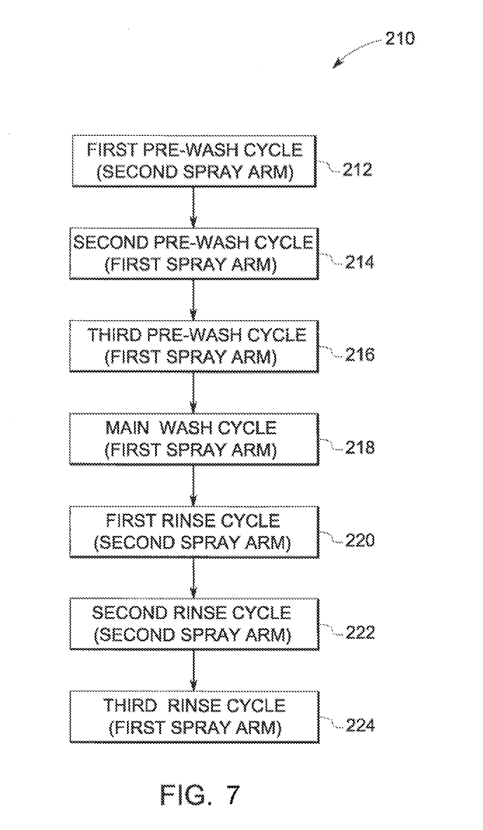

As described above, the spray arms 54 and 56 (see FIG. 2) of the spray device 50 are selectively operated based upon a desired mode of operation of the appliance 10. In certain embodiments, the first and second spray arms 54 and 56 may be operated simultaneously to achieve a desired flow rate of the water within the appliance 10. FIG. 7 illustrates an exemplary operational cycle 210 for the appliance 10 of FIG. 1. Typically, the appliance 10 employs a series of pre-wash, wash and rinse cycles having a preset operation time for washing the dishes. As described above, the spray device 50 employed in the appliance may be controlled based upon a desired operational cycle of the appliance 10. In particular, the first and second spray arms 54 and 56 may be operated based upon the operational cycle of the appliance.

In the illustrated embodiment, the operational cycle 210 includes a first pre-wash cycle 212 for removing loose particles from the dishes. For this cycle 212, the second spray arm 56 having the second set of nozzles 60 is employed for spraying water on the dishes. Next, the first spray arm 54 having the first set of nozzles 58 is operated for a second and a third pre-wash cycle, as represented by reference numerals 214 and 216. Further, the first spray arm 54 is operated for washing the dishes during a main wash cycle 218. In addition, the rinse cycle employs the second spray arm 56 for first and second rinse cycles 220 and 222 and the first spray arm 54 for a third rinse cycle 224.

As will be appreciated by one skilled in the art based upon a desired flow rate for each of these cycles, the first and second spray arms 54 and 56 may be controlled by the control system 34 (see FIG. 1) thereby using an optimum amount of water and energy for the operational cycle 210 of the appliance 10. As illustrated, the exemplary cycle 210 includes three pre-wash cycles, a main wash cycle and three rinse cycles having a pre-determined running time. However, the appliance 10 may employ a greater or lesser number of such cycles. Again, based upon the number of cycles and the desired flow rate of water, the first and second spray arms 54 and 56 may be selectively controlled during operation of the appliance 10. In certain embodiments, the first and second spray arms 54 and 56 may be operated simultaneously to achieve a desired flow rate. In certain other embodiments, either one of the spray arms 54 and 56 may be operated for all the cycles.

In addition to reducing solvent usage and energy usage by employing first and second spray arms 54 and 56 with different flow rates for different cycles (e.g., wash, pre-wash, rinse) as discussed above, the dual spray arms 54, 56 can also provide better solvent spray coverage when they are operated to rotate the spray device in two directions. As can be seen in FIG. 2, the direction of rotation and RPM of dual spray arms 54, 56 can be controlled by the direction and force of the solvent jet (e.g., water jet) flowing from the nozzles 58, 60 when the water is introduced within the appliance 10. For example, the geometry (e.g., angle and diameter) of the nozzles 58, 60 can determine the direction and force of the water jet, with a larger diameter nozzle 58, 60 providing a greater driving force and higher RPM than a smaller diameter nozzle 58, 60. The driving force and RPM of the spray arms can be also determined by the particular flow rate provided by the pumps 62, 64.

In one embodiment, the first spray arm 54 can have a first set of nozzles 58 that are configured to spray the water in a direction and at angles that drive the first spray arm 54 to rotate in a first direction (e.g., clockwise). When the first spray arm 54 and the spray device are rotating in the clockwise direction, the spray from the first spray arm 54 contacts a particular dish on one side. Similarly, the second spray arm 56 can have a second set of nozzles 60 that are configured to spray the water in a direction and at angles that drive the second spray arm 56 to rotate in a second direction (e.g., counterclockwise). When second spray arm 56 and the spray device are rotating in the counter-clockwise direction, the spray from the second spray arm 56 contacts that same dish on the other side. Accordingly, when the nozzles 58, 60 are configured to rotate the spray device in two directions, a cycle (pre-wash, wash, or rinse) can employ both spray arms 54, 56 to improve spray coverage over conventional single-direction spray devices.

As discussed above and as can be seen in FIG. 2, the spray device 50 of the dual directional system can include a pumping system coupled to the first spray arm 54 and the second spray arm 56. In the exemplary embodiment shown in FIG. 2, a first pump 62 is coupled to the first spray arm 54 and a second pump 64 is coupled to the second spray arm 56. The flow rate of the first pump 62 can be the same or different than the flow rate of the second pump 64. In certain embodiments, the spray device 50 has a pumping system having a single pump and a valve system (not shown) employed for directing water from the pump to the first and second spray arms 54 and 56. The valve system can be operated by, e.g., a ball or a solenoid. Based upon a mode of operation of the appliance 10, the flow of water from the pumping system to the first and second spray arms 54 and 56 is controlled via the control system 34 (see FIG. 1).

In certain modes of operation, the first spray arm 54 and second spray arm 56 can be operated at different times from each other (i.e., not at the same time). For example, when the first spray arm 54 is spraying water, the second spray arm 56 is not spraying water, causing the spray device to rotate in a clockwise direction with its RPM and flow rate determined by the nozzles 58 of the first spray arm 54 and the capacity of the first pump 62. Similarly, when the second spray arm 56 is spraying water, the first spray arm 54 is not spraying water, causing the spray device to rotate in a counterclockwise direction with its RPM and flow rate determined by the nozzles 60 of the second spray arm 56 and the capacity of the second pump 64.

In another mode of operation, the first spray arm 54 and second spray arm 56 can be operated at the same time (i.e., when the first spray arm 54 is spraying water, the second spray arm 56 is also spraying water). In this simultaneous mode of operation, if the first spray arm 54 has a higher driving force than the second spray arm 56, the spray device will rotate in the first or clockwise direction (i.e., the direction of the first spray arm 54). While the spray device will rotate at a slower RPM than if the first spray arm 54 was operated independently since the second spray arm 56 is driving in an opposite (counterclockwise) direction, the spray device will provide a higher flow rate from both spray arms 54, 56. Similarly, in this simultaneous mode of operation, if the second spray arm 56 has a higher driving force than the first spray arm 54, the spray device will rotate in the second or counterclockwise direction (i.e., the direction of the second spray arm 56). While the spray device will rotate at a slower RPM than if the second spray arm 56 was operated independently since the first spray arm 54 is driving in an opposite (clockwise) direction, the spray device will provide a higher flow rate from both spray arms 54, 56.

The various aspects of the method described hereinabove have utility in appliances such as dishwashers. As noted above, the appliance employs a spray device having a dual spray arm configuration that utilizes substantially lower amounts of water and energy for washing the dishes. Further, the spray device described above provides sufficient coverage for all modes of operation of the appliance while maintaining the low washing solvent usage.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A spray device, comprising:
a first spray arm having a first set of nozzles configured to introduce a solvent within the appliance in a manner that drives the first spray arm to rotate in a first direction;
a second spray arm having a second set of nozzles configured to introduce the solvent within the appliance in a manner that drives the second spray arm to rotate in a second direction, wherein the second direction is opposite of the first direction;
a pumping system coupled to the first spray arm and the second spray arm; and
a control system configured to control a flow of the solvent from the pumping system to the first spray arm and to control a flow of solvent from the pumping system to the second spray arm.

2. The spray device of claim 1, wherein the pumping system comprises a first pump coupled to the first spray arm and a second pump coupled to the second spray arm.

3. The spray device of claim 1, wherein the pumping system comprises a pump coupled to the first spray arm and the second spray arm and a valve configured to direct the solvent from the pump to the first spray arm and the second spray arm.

4. The spray device of claim 1, wherein the second spray arm is transverse to the first spray arm.

5. The spray device of claim 1, wherein the first set of nozzles of the first spray arm is configured to provide a different driving force than the second set of nozzles of the second spray arm.

6. The spray device of claim 1, further comprising:
a hub, wherein the first spray arm and the second spray arm are mounted to the hub.

7. The spray device of claim 6, further comprising:
first and second inlets mounted on the hub; and
a first channel in fluid communication with the first inlet and the first set of nozzles and a second channel in fluid communication with the second inlet and the second set of nozzles.

8. The spray device of claim 7, wherein the first and second channels are disposed in a concentric configuration.

9. An appliance, comprising:
a sump configured to store solvent for washing objects placed in the appliance;
a spray device configured to spray the solvent from the sump over the objects, wherein the spray device comprises:
a first spray arm having a first set of nozzles configured to introduce the solvent within the appliance in a manner that drives the first spray arm to rotate in a first direction;
a second spray arm having a second set of nozzles configured to introduce the solvent within the appliance in a manner that drives the second spray arm to rotate in a second direction, wherein the second direction is opposite of the first direction;
a pumping system coupled to the sump and configured to pump solvent contained in the sump to the first spray arm and the second spray arm; and
a control system configured to control a flow of the solvent from the pumping system to the first spray arm and to control a flow of solvent from the pumping system to the second spray arm.

10. The appliance of claim 9, wherein the pumping system comprises a first pump coupled to the first spray arm and a second pump coupled to the second spray arm.

11. The appliance of claim 9, wherein the pumping system comprises a pump coupled to the first spray arm and the second spray arm and a valve responsive to the control system and configured to selectively direct the solvent from the pump to the first spray arm and the second spray arm.

12. The appliance of claim 10, wherein the first pump has a different flow rate than the second pump.

13. The appliance of claim 9, wherein the first set of nozzles of the first spray arm is configured to provide a different driving force than the second set of nozzles of the second spray arm.

14. A method of operating a spray device of an appliance, said method comprising:
introducing a solvent within the appliance in a manner that drives a first spray arm to rotate in a first direction;
introducing the solvent within the appliance in a manner that drives a second spray arm to rotate in a second direction, wherein the second direction is opposite of the first direction; and
controlling a flow of the solvent from a pumping system of the appliance to the first spray arm and controlling a flow of solvent from the pumping system to the second spray arm.

15. The method of claim 14, further comprising directing solvent from a first pump into the first spray arm and directing solvent from a second pump into the second spray arm.

16. The method of claim 14, further comprising directing solvent from a pump into the first and second spray arms through a valve system.

17. The method of claim 14, wherein introducing the solvent within the appliance in a manner that drives the first spray arm to rotate in the first direction occurs at a different time than the step of introducing the solvent within the appliance in a manner that drives the second spray arm to rotate in the second direction, wherein the second direction is opposite of the first direction.

18. The method of claim 14, wherein introducing the solvent within the appliance in a manner that drives the first spray arm to rotate in the first direction occurs at the same time as the step of introducing the solvent within the appliance in a manner that drives the second spray arm to rotate in the second direction, wherein the second direction is opposite of the first direction.

19. The method of claim 18, wherein the first spray arm is configured to provide a greater driving force than the second spray arm, causing the spray device to rotate in the first direction.

20. The method of claim 18, wherein the second spray arm is configured to provide a greater driving force than the first spray arm, causing the spray device to rotate in the second direction.
